(19) United States
(12) Patent Application Publication
(10) Pub. No.: US 2017/0232653 A1
(43) Pub. Date: Aug. 17, 2017

(54) Method and Device for the Production and Further Processing of a Film Tube

(71) Applicant: Windmöller & Hölscher KG, Lengerich (DE)

(72) Inventors: Ingo Putsch, Lengerich (DE); Ali Hassan, Lengerich (DE); Ingo Hehmann, Hagen a.T.W. (DE)

(21) Appl. No.: 15/518,733

(22) PCT Filed: Sep. 13, 2015
(86) PCT No.: PCT/EP2015/073632

§ 371 Date: Apr. 12, 2017

(30) Foreign Application Priority Data
Oct. 15, 2014 (DE) 10 2014 220 936.6

(51) Int. Cl. B29C 47/00; B29C 53/20; B65B 7/02; B65B 5/06; B65B 5/08; B29C 47/92; B29C 55/22

(52) U.S. Cl. CPC B29C 47/0059; B29C 47/0026; B29C 47/92; B29C 53/20; B29C 55/22; B65B 5/061; B65B 5/08; B65B 7/02; B29C 2947/92704; B29L 2031/7128

(57) ABSTRACT

The invention describes a method for the production and further processing of a film tube (6), in which method a plastic melt is transferred into a cylindrical melt by means of an extrusion die (4), the melt flow is drawn out through an annular gap (5) associated with the extrusion die (4) in order to form the film tube (6), and at least one temperature-controlled volume flow comprising at least one fluid is conducted by means of a temperature control device (8) onto the outer periphery of the film tube (6), wherein the temperature control device (8) is divided into peripheral segments, wherein a volume flow of different magnitude and/or different temperature is produced by means of each peripheral segment such that the temperature control of the film tube (6) differs over the periphery of the film tube, and wherein the film tube (6) is flattened by means of a flattening device (9), the flattening device (9) being rotated in relation to the extrusion die (4). A first volume flow in at least one peripheral segment of the temperature control device (8) differs from the volume flow of other peripheral segments so that at least one thick point (13) is produced on the film tube, wherein the first volume flow is produced by means of adjacent peripheral segments in succession, wherein the first volume flow is produced by means of the corresponding at least one peripheral segment in such a way that the first volume flow is adapted to the rotation of the flattening device (9) such that the at least one thick point (13) assumes substantially the same position in relation to the flattening device (9).

The invention relates to a method for the production and further processing of a film tube according to the preamble of claim 1 and to a device for the production and further processing of a film tube according to the preamble of claim 14.

During such a process, a plastic melt is transferred into a cylindrical melt flow in an extrusion die. This is frequently carried out in a spiral distributor, however mandrel dies are known that may also be used for said purpose. The melt flow is then drawn out through a tubular die, which is associated with the extrusion die, more particularly is a component thereof. The film is then cooled to form a film tube. The film may be simply cooled in the ambient air, however in practice, a temperature control device is used, with which a temperature-controlled volume flow of a fluid is directed onto the film tube, preferably onto its outer periphery, but additionally or alternatively onto its inner periphery if necessary. Frequently, this temperature control device is divided into peripheral segments, so that the respective peripheral segments of the film tube can be acted on by different magnitudes of the volume flow (“magnitude” is understood in this context as the amount of fluid per unit of time) and/or can be acted on by different volume flow temperatures. In this way, irregularities in film thickness, as inevitably occur in known extrusion dies, can be compensated for. When a peripheral segment of the film tube is acted on by a lower volume flow and/or a higher temperature, the as yet unsolidified film tube will have a lower viscosity in that segment as compared with adjacent peripheral segments, so that the film tube will “run” more and become thinner at those points. A more intense cooling as compared with adjacent areas will produce the opposite result. At such points the film—at least initially—will retain its thickness. Nevertheless, irregularities—though minor—in the thickness of the film tube frequently occur over its periphery. To prevent these irregularities from impacting subsequent processing steps, the film tube is further processed as follows. As a rule, the film tube is flattened after its production. This involves introducing lateral fold edges and bringing the resulting film layers into contact with one another.

A flattening device, with which the aforementioned step is carried out, is often rotated relative to the—generally fixed—extrusion die. However, during this process, the fold edges “migrate” over the outer periphery of the film tube, and with them also the irregularities in the film thickness.

Film tubes of this type are further processed for various purposes. Often, these involve packaging operations for which the film is required.

Regardless of the type of application for which the film is used, it has been found that such films are often subjected to greater stresses at certain points than at other points. The thickness of the produced film is adapted to these maximum stresses, which naturally leaves some regions of the film with excess thickness. Thus it is clear that too much film material is being used, resulting in overly high costs.

It is therefore the object of the present invention to propose a method and a device for the production and further processing of a film tube with which material and thus costs can be saved.

The object is achieved by all the features of claim 1.

It is provided therein that a first volume flow in at least one peripheral segment of the temperature control device is different from the volume flow of other peripheral segments, so that at least one thick point is produced on the film tube, wherein the first volume flow is produced by means of adjacent peripheral segments in succession, and the first volume flow is produced by the corresponding at least one peripheral segment in such a way that the first volume flow is adapted to the rotation of the flattening device such that the at least one thick point assumes substantially the same position in relation to the flattening device.

Within the scope of the present disclosure, the word “a” and similar words are merely indefinite articles for the nouns that follow them. They should not be construed in any way as a numerical limitation unless otherwise explicitly stated.

Thus at least one thick point is produced in a deliberate manner in order to provide the film with greater mechanical strength, for example, at the points in question. This allows the overall thickness of the film to be reduced as compared with a conventional film tube for a specific intended application, with the original film thickness being provided for the specific thick points. Thick points in this context are not intended to be understood as thicker points that inevitably occur in the production of films of maximum uniform thickness, but as purposefully thick points that deviate from the nominal thickness or the actual average thickness by at least 10%, in particular by at least 20%, preferably by 30%.

To create such a thick point, it is provided that the peripheral segment in question of the film tube is cooled more rapidly than adjacent segments. For this purpose, the peripheral segment in question of the temperature control device produces a greater volume flow and/or a volume flow that has a lower temperature than surrounding peripheral segments. Adjusted parameters are thereby established.

However, these adjusted parameters are not fixedly linked to one peripheral segment of the temperature control device. On the contrary, in the case of a rotating flattening device, it is provided that these adjusted parameters are established in adjacent peripheral segments of the temperature control device in succession, while in the peripheral segment in which the adjusted parameters are already established, the parameters are reverted to the original parameters. In this way, the thick point can be moved over the periphery of the film tube. The peripheral segments of the temperature control device are acted on in succession based on the rotational movement of the flattening device. In this process, it is provided that the thick point assumes substantially the same position in relation to the flattening device and does not move relative thereto.

The thickness of the film can be adjusted by means of a control unit or regulating device. In principle, provision can be made for producing the film tube with the minimum deviation from a nominal thickness or a mean thickness. A thick point is then superimposed over this thickness, resulting in a desired thickness profile of the film tube over the periphery thereof. The thickness can be measured by means of a thickness gauge. These measurement data can be fed to a control and/or regulating device, which then issues control commands to the peripheral segments of the temperature control device. Data about the thick points can also be communicated to the control and/or regulating device, allowing it to produce these thick points by appropriately actuating peripheral segments of the temperature control device. The control and/or regulating device advantageously also controls the rotational movement of the flattening device or at least receives data about the rotational movement thereof. The production of thick points can then be adapted.

In a further embodiment of the invention, it is provided to guide the flattened film tube through a reversing device. A reversing device is a device in which deflecting rollers and turning bars are arranged at a distance from the tube axis, with their axial extension extending transversely to the tube axis. By pivoting the deflecting rollers and turning bars about the tube axis, the film tube can be pulled off by means of a fixedly arranged pair of transport rollers, even while the flattening device is rotating. Such a reversing device ensures that the thick points remain at their intended positions and do not subsequently become displaced relative to the fold edges.

In a further embodiment it is provided that at least two thick points are introduced into the film tube. Such a number offers advantages, since a symmetrically configured film is required for many applications. For instance, the tube may be used for producing bags. In that case, the thick points could be arranged running around the fold edges to compensate for the weakening of the material caused by the fold edges.

When an even number of thick points are provided, it is also advantageous for two thick points to always be arranged opposite one another, i.e. offset by a peripheral angle of 180 degrees, which in turn results in a symmetrical design.

In a further, preferred embodiment of the invention, lateral folds are introduced into the film tube. A combination of thick points and lateral folds enables the film to be prefabricated suitably for various applications during film production.

Particular preference is given here to the introduction of a thick point at a position on the film where an outer edge of a lateral fold will be placed. In this way, those points that are heavily stressed during subsequent processing can also be made selectively durable in the case of laterally folded tubes, without having to produce the entire film tube as durable and thus material-intensive.

A film tube produced with the above-described embodiments can be further processed in a variety of ways.

The simplest type of further processing involves winding the film tube. The film tube may be wound in tube form. The film tube may also be cut open in the regions of the two lateral edges. Film webs that are separated in this way can then be further processed independently of one another, each in a winding device, to produce a reel. Finally, only one lateral edge may be cut open and the unfolded tube can then be wound. A film of this type could be used directly by the end user. End users frequently require films that have reinforced lateral edges; these can be produced very easily by the method according to the invention.

In a further advantageous further processing variant, it is provided that the flattened film tube is fed to a device for packaging multiple stacked objects, in which case the film is gripped at holding positions by pulling means and is pulled over the objects. Such devices are often referred to as stretch hood systems. The term “stacked objects” may, for example, refer to a pallet on which a single additional object is arranged, such as a household appliance. Another example would be a stacked arrangement of multiple, in particular similar objects. This arrangement may likewise be located on a pallet, but may also be configured without a pallet. The pulling means, which comprises multiple holding elements, grips the film at specific holding positions and then pulls the film over the stacked objects. These holding positions are preferably the outer edges of lateral folds that have been introduced into the film tube. The pulling means may also be capable of picking up portions of the film tube proceeding from the holding positions, so that the pulling of the film tube more resembles a placement of the film tube on the stacked objects. During the described packaging of stacked objects, the film is exposed to heavy stresses, in particular at the holding positions, therefore the film must have sufficient thickness at these points. At the other points, stresses and thus also the requirements in terms of the film thickness are lower, so that the method according to the invention can lead to cost savings.

A further advantageous embodiment of the invention provides for feeding the flattened film tube to a device for forming, filling and sealing bags. In such a device, an empty bag is first produced from the film tube by cross-sealing the leading end of the tube and cutting off a piece of tube that is open at the top. This empty bag is fed to a filling station, where it can be filled. The upper end is then likewise sealed in a sealing station. The feature of interest in such a device is that the piece of tube is held by device components, generally grippers, from a time before it is cut off until after its upper end has been sealed. In this case as well, the lateral folds are subjected to heavy stress, particularly at the points where the cross-sealing intersects with or meets up with the outer edges. Thus a greater film tube thickness along the outer edges of the lateral folds as compared with the remaining parts is also advantageous here.

In a further variant of the invention, the flattened film tube may also be supplied to a stretching apparatus in which it is stretched in the transport direction. In such a stretching apparatus, the film tube or a film web produced therefrom is heated, and is stretched in its transport direction by up to ten times its original length. In this case, thick points along the edges of the film tube or the film web can help to reduce the neck-in that occurs in such processes, since the film is held more securely through the roller nip by means of the thick points. In place of or in addition to thick points, thin points may also be provided, which can compensate in advance for the thickened regions that occur simultaneously with the neck-in.

An advantageous refinement of the method according to the invention provides for the peripheral segment of the temperature control device with which the first volume flow is produced to deviate by an angle from the angular position that is assumed by the flattening device during its rotational movement. The winding position of the first volume flow is thus “advanced” in relation to the position where the thick point will be arranged relative to the flattening device. This is advantageous because a section of film that has been acted on by a volume flow at one point in time requires a certain amount of time before it reaches the flattening device. Without such an advancement, a thick point would be observed in an undesired position in the flattened film tube. However, no advancement takes place at the turning points of the flattening device.

Turning points are observed when the flattening device is rotated in a reversing manner, i.e. when it is rotated back and forth between two angular positions. A reversing operation of the flattening device is generally advantageous with the present invention.

The advancement advantageously amounts to at least 5°, in particular at least 10°.

The object stated at the outset can also be achieved according to the features of claim 14 by the fact that a first volume flow in at least one peripheral segment of the temperature control device differs from the volume flow of other peripheral segments, so that at least one thin point is produced on the film tube, with the first volume flow being produced by means of adjacent peripheral segments in succession, and with the first volume flow being produced by the corresponding at least one peripheral segment in such a way that the first volume flow is adapted to the rotation of the flattening device, such that the at least one thin point assumes substantially the same position in relation to the flattening device.

In this case, it is thus possible to make the film tube thinner at angular positions where a lower film strength is required as compared with other angular positions. Moreover, the features of claims 1 and 14 may also be combined in order to achieve additional savings in terms of material and costs.

The object is further achieved by a device according to claim 15.

Further advantages, features and details of the invention will be apparent from the following description, in which various exemplary embodiments are explained in detail with reference to the FIGURES. The features mentioned in the claims and in the description can each be considered essential to the invention, alone or in any combination of the mentioned features. Within the scope of the disclosure as a whole, features and details that are described in connection with the method of the invention can, of course, also be applied in connection with the device of the invention, and vice versa, so that reference always is or can be reciprocal with respect to the disclosure of the individual aspects of the invention. The individual FIGURES show:

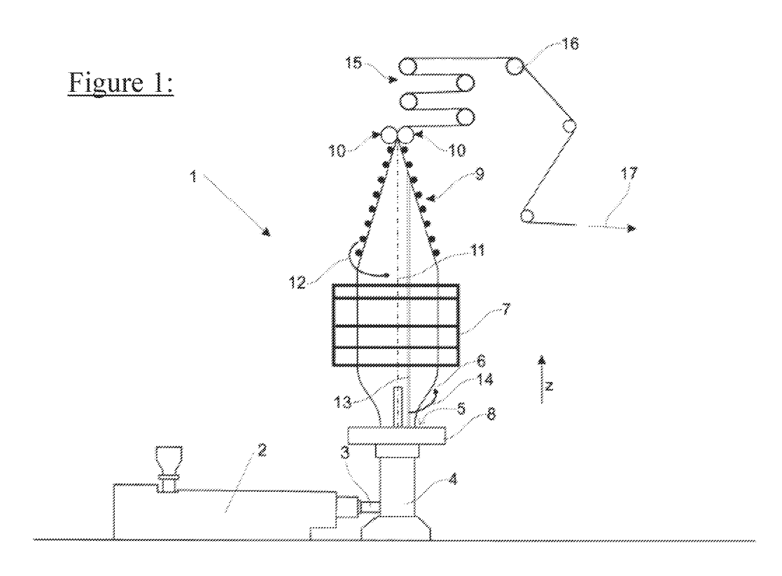

FIG. 1 a side view of a device for producing a film tube

FIG. 1 shows a device 1 for producing a film tube, which comprises firstly at least one extruder 2, with which plastic in granular form, for example, can be plasticized. The plastic melt thus produced is supplied via a line 3 to an extrusion die 4, where this melt is transferred into a cylindrical melt flow, so that this melt flow can be drawn out through an annular gap 5, not visible in this FIGURE, in take-off direction z. An as yet unsolidified film tube 6 is thus produced. This is inflated from the inside by a slight overpressure such that it has a greater diameter inside the optional calibration device 7. The film tube is solidified by means of a temperature control device 8, which is often also referred to as a cooling ring due to its ring-like configuration surrounding the film tube.

After passing through the calibration device, the film tube 6 reaches the operating area of a flattening device 9, in which the circular film tube is transferred into an ellipsoidal cross-section with increasing eccentricity, until finally, in the operating area of the take-off rollers, it forms two film webs lying one on top of the other and joined with one another along their sides.

The flattening device is arranged as rotatable, with the axis of rotation being aligned substantially with the tube axis 11, which in FIG. 1 is indicated by a dashed-dotted line. The rotatability of the flattening device is indicated by the arrow 12.

Temperature control device 8 is divided into various peripheral segments. Each peripheral segment of the temperature control device is capable of applying an individual volume flow (amount of fluid per unit of time) and/or a volume flow at an individual temperature to the film tube. Air is preferably provided as the fluid. The peripheral segment of the film tube that is associated with the peripheral segment of the temperature control device in question can thus be individually temperature controlled, in particular cooled. The peripheral segments of the film tube that no longer “run” as much due to the greater cooling action of the temperature control device form a thick point 13, which is indicated in the FIGURE by a double line.

To ensure that the thick point always arrives at a fixed position on the flattening device, it is also necessary for the thick point to move along the periphery, as indicated by arrow 14 in the FIGURE. This “migration” of the thick point is achieved by altering the parameters of the next closest peripheral segment of the temperature control device in the direction of arrow 14 in order to produce a thick point adjacent to the peripheral segment of the film tube that already has such a thick point. The current thick point is returned to the original parameters by the peripheral segment in question of the temperature control device then decreasing its cooling action on the angular segment associated with it.

FIG. 1 further shows a reversing device 15, the function of which is to guide the flattened film tube from the flattening device to the stationary roller 16 without damaging it. As indicated by arrow 17, this film tube is then conducted to further processing, which is not specified in greater detail here.

List of Reference Signs

| | |
|---|---|
| 1 | Device |
| 2 | Extruder |
| 3 | Line |
| 4 | Extrusion die |
| 5 | Annular gap |
| 6 | Film tube |
| 7 | Calibration device |
| 8 | Temperature control device |
| 9 | Flattening device |
| 10 | |
| 11 | Tube axis |
| 12 | Arrow |
| 13 | Thick point |
| 14 | Arrow |
| 15 | Reversing device |
| 16 | Roller |
| 17 | Arrow |
| 18 | |
| 19 | |
| 20 | |
| 21 | |
| 22 | |
| 23 | |
| 24 | |

1-15. (canceled)

16. A method for the production and further processing of a film tube, in which method
a plastic melt is transferred into a cylindrical melt flow by means of an extrusion die,
the melt flow is drawn out through an annular gap associated with the extrusion die in order to form the film tube,
at least one temperature-controlled volume flow comprising at least one fluid is conducted onto the outer periphery of the film tube by means of a temperature control device, wherein the temperature control device is divided into peripheral segments, wherein a volume flow of different size and/or different temperature is produced by means of each peripheral segment such that the temperature control of the film tube differs over the periphery of the film tube,
the film tube is flattened by means of a flattening device, wherein the flattening device is rotated in relation to the extrusion die,
a first volume flow in at least one peripheral segment of the temperature control device is different from the volume flow in other peripheral segments, wherein at least one thick point is produced on the film tube,
wherein the first volume flow is produced by means of adjacent peripheral segments in succession, and wherein the first volume flow is produced by the corresponding at least one peripheral segment in such a way that the first volume flow is adapted to the rotation of the flattening device such that the at least one thick point assumes substantially the same position in relation to the flattening device,
wherein
the thickness of the thick point deviates from the nominal thickness or the actual average thickness by at least 20%, preferably by 30%, and
in that lateral folds are introduced into the film tube, wherein the thick point is produced at an angular position on the film tube where an outer edge of a lateral fold is placed.

17. The method according to claim 16, wherein a first volume flow in at least one peripheral segment of the temperature control device is different from the volume flow of the directly adjacent peripheral segments.

18. The method according to claim 16, wherein, after being flattened, the film tube is conducted through a reversing device.

19. The method according to claim 16, wherein at least two thick points are introduced into the film tube.

20. The method according to claim 16, wherein when an even number of thick points are provided, two thick points are introduced opposite one another.

21. The method according to claim 16, wherein the flattened film tube is wound in a winding device to form a reel.

22. The method according to claim 16, wherein the flattened film tube is fed to a device for packaging a plurality of stacked objects, wherein the film is gripped at holding positions by pulling means and is pulled over the objects.

23. The method according to claim 16, wherein the flattened film tube is fed to a device for forming, filling and sealing bags, where it is processed to produce filled and sealed bags.

24. The method according to claim 16, wherein the flattened film tube is fed to a stretching apparatus in which it is stretched in the direction of transport.

25. The method according to claim 16, wherein the peripheral segment by means of which the first volume flow is produced deviates by an angle from the angular position assumed by the flattening device during its rotation.

26. The method according to claim 16, wherein the angle deviates from the angular position by at least 5°, in particular by at least 10°.

27. A device for producing and further processing a film tube, the device comprising:
an extrusion die for transferring a plastic melt into a cylindrical melt flow,
an annular gap which is associated with the extrusion die and through which the melt flow can be drawn out to form the film tube,
a temperature control device for conducting at least one temperature-controlled volume flow comprising at least one fluid onto the outer periphery of the film tube, wherein the temperature control device is divided into peripheral segments, wherein a volume flow of different size and/or different temperature can be produced by means of each peripheral segment so that the temperature of the film tube can be controlled differently over its periphery, and
a flattening device with which the film tube can be flattened, wherein the flattening device is rotatable relative to the extrusion die,
a first volume flow can be produced in at least one peripheral segment of the temperature control device, which volume flow differs from the volume flow of other peripheral segments, wherein at least one thick point can be produced on the film tube, wherein the first volume flow can be produced by means of adjacent peripheral segments in succession, wherein the first volume flow can be produced by the corresponding at least one peripheral segment in such a way that the first volume flow is adapted to the rotation of the flattening device such that the at least one thick point assumes substantially the same position in relation to the flattening device, wherein
the thickness of the thick point deviates from the nominal thickness or the actual average thickness by at least 20%, preferably by 30%, and in that lateral folds can be introduced into the film tube, wherein the thick point is produced at an angular position on the film tube where an outer edge of a lateral fold is placed.
